(19) United States
(12) Patent Application Publication
(10) Pub. No.: US 2011/0321046 A1
(43) Pub. Date: Dec. 29, 2011

(54) PROCESS INFORMATION MANAGEMENT APPARATUS AND METHOD, IMAGE FORMING APPARATUS, AND COMPUTER READABLE MEDIUM STORING PROGRAM THEREFOR

(75) Inventors: Tomomichi ADEGAWA, Kanagawa (JP); Yoshiaki TEZUKA, Kanagawa (JP); Kunihiko KOBAYASHI, Kanagawa (JP); Tsuyoshi WATANABE, Kanagawa (JP)

(73) Assignee: FUJI XEROX CO., LTD., Tokyo (JP)

(21) Appl. No.: 12/940,704

(22) Filed: Nov. 5, 2010

(30) Foreign Application Priority Data
Jun. 28, 2010 (JP) 2010-146762

(51) Int. Cl. G06F 9/46

(52) U.S. Cl. 718/100

(57) ABSTRACT

A process information management apparatus includes a first processor, a management unit, a second processor, a generator, and a third processor. The first processor executes a first process based on a first application program in an environment where a first system is operating. The management unit manages information regarding a process executed in an environment where a second system is operating, based on a second application program in the environment. The second processor executes a second process based on the second application program in the environment. The generator generates, when the first process is executed, an execution instruction for a third process corresponding to the first process to regard the first process is executed in the environment, and, when the first process is completed, generates a completion instruction for the third process. Based on the second application program in the environment, the third processor executes and completes the third process.

### CROSS-REFERENCE TO RELATED APPLICATIONS

This application is based on and claims priority under 35 USC 119 from Japanese Patent Application No. 2010-146762 filed Jun. 28, 2010.

### BACKGROUND

The present invention relates to a process information management apparatus and method, an image forming apparatus, and a computer readable medium storing a program therefor.

### SUMMARY

According to an aspect of the invention, there is provided a process information management apparatus including a first processor, a management unit, a second processor, a generator, and a third processor. The first processor executes a first process for each process unit instructed to be executed, based on a first application program in an environment where a first system is operating. The management unit manages information regarding a process executed in an environment where a second system is operating, based on a second application program in the environment where the second system is operating. The second processor executes a second process for each process unit instructed to be executed, based on the second application program in the environment where the second system is operating. The generator generates, when the first processor executes the first process, an execution instruction for causing a third process corresponding to the first process to be executed in order to regard that the first process is executed in the environment where the second system is operating, and, when the first processor completes the first process, generates a completion instruction for completing execution of the third process. The third processor executes, based on the second application program in the environment where the second system is operating, the third process in accordance with the execution instruction generated by the generator, and completes the third process in accordance with the completion instruction.

### BRIEF DESCRIPTION OF THE DRAWINGS

Exemplary embodiment(s) of the present invention will be described in detail based on the following figures, wherein:

FIG. 1 is a schematic block diagram illustrating an example of the configuration of an image forming apparatus according to an exemplary embodiment;

FIG. 2 is a diagram schematically illustrating a state in which the image forming apparatus according to the exemplary embodiment and a terminal apparatus are connected to each other via a computer network;

FIG. 3A is a conceptual diagram illustrating the case where no additional application is provided;

FIG. 3B is a conceptual diagram illustrating the relationship among programs in the case where an additional application is provided;

FIG. 4 is a diagram illustrating an example of the schematic configuration for explaining a job information management function in a process information management apparatus according to the exemplary embodiment;

FIG. 5 is a chart for explaining a sequence example in the case where a copy job is executed in an existing system according to the exemplary embodiment;

FIG. 6 is a diagram for explaining specific examples of types of jobs set in a setting unit in the existing system according to the exemplary embodiment;

FIG. 7 is a chart for explaining a sequence example in the case where information regarding the copy job being executed in the existing system according to the exemplary embodiment is changed;

FIG. 8 is a diagram for explaining a specific example of information (job information) regarding a job according to the exemplary embodiment;

FIG. 9 is a chart for explaining a sequence example in the case where a user gives a copy suspension instruction to a pseudo-job being executed in an additional system according to the exemplary embodiment;

FIG. 10 is a chart for explaining a sequence example in the case where a scan job using a function of the existing system is executed by a processor in the additional system according to the exemplary embodiment;

FIG. 11 is a diagram for explaining a specific example of a job list according to the exemplary embodiment; and

FIG. 12 is a schematic block diagram illustrating another example of the configuration of the image forming apparatus according to the exemplary embodiment.

### DETAILED DESCRIPTION

An exemplary embodiment of the invention will be described in detail with reference to the drawings.

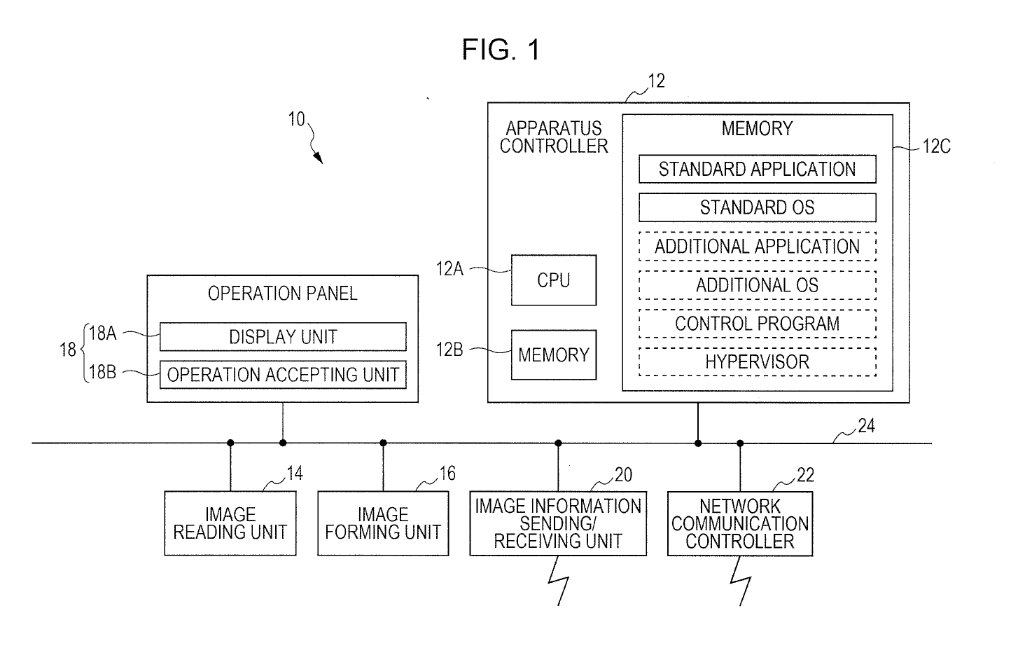

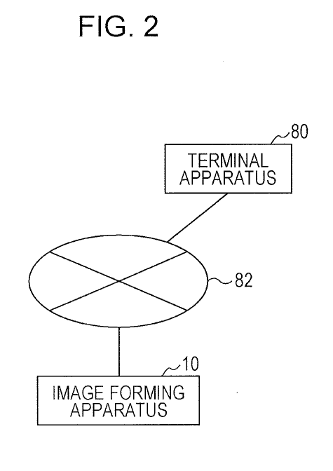

FIG. 1 illustrates an image forming apparatus 10 according to an exemplary embodiment. The image forming apparatus 10 at least includes an apparatus controller 12 that controls the operation of each unit of the image forming apparatus 10, an image reading unit 14 that optically reads a document (paper document) to be read that has been set and outputs the read image data, an image forming unit 16 that forms an image represented by the input image data on a recording sheet, an operation panel 18 including a display unit 18A that includes a liquid crystal display (LCD) or the like and an operation accepting unit 18B that includes a numerical pad and a touch panel and that accepts an operation entered by a user, an image information sending/receiving unit 20 that sends/receives image information (facsimile communication) with another device with a function as a facsimile apparatus via a telephone line and a public telecommunication network (not illustrated), and a network communication controller 22 for sending/receiving information to/from a terminal apparatus 80 such as a personal computer (PC) via a network cable and a computer network 82 (see FIG. 2). These units are connected to one another via a bus 24.

The apparatus controller 12 includes a microcomputer or the like, and includes a central processing unit (CPU) 12A, a memory 12B, and a non-volatile memory 12C including a hard disk drive (HDD) or a flash memory. The memory 12C at least stores a standard application program and a standard operating system (standard OS) program. The standard application program is for performing a process of providing standard functions (such as a copy function and a facsimile transmission/reception function) of the image forming apparatus 10 to a user of the image forming apparatus 10, for performing input/output control that gives a control command and controls the operation of an input/output unit such as the image reading unit 14 or the image forming unit 16, and for performing screen control for displaying, on the display unit 18A, a screen for providing the standard functions. The standard OS program functions as a platform for executing the standard application program.

Also, the image forming apparatus 10 according to the exemplary embodiment is able to add a new function that may be provided to the user of the image forming apparatus 10 by additionally storing an additional application program or the like in the memory 12C of the apparatus controller 12. In FIG. 1, programs for providing additional functions are indicated by broken lines. The memory 12C of the apparatus controller 12 stores an additional application program for performing a process of providing an additional function and performing screen control for displaying, on the display unit 18A, a screen and a menu screen for providing the additional function, an additional operating system (additional OS) program that functions as a platform for executing the additional application program, a control program for performing a process such as separating a process realized with the standard application and a process realized with the additional application, and a hypervisor program that provides functions such as virtualization of hardware resources, arbitration of common resources between the standard OS and the additional OS, and communication between the standard OS and the additional OS.

As a specific example, when an OS that activates a copy function or a facsimile function of the image forming apparatus 10 is a real-time OS, the real-time OS serves as a standard OS, and the copy function or the facsimile function operating on the standard OS serves as a standard application. A real-time OS is an OS configured with an emphasis on a response time for a process request such as an external interruption to be within a certain range (assurance of immediate responsiveness) in order to execute a process in real-time. In this case, an additional OS is an OS configured with no emphasis on the assurance of immediate responsiveness, but with an assumption that this OS will be generally used in various cases. An application operating on the additional OS serves as an additional application.

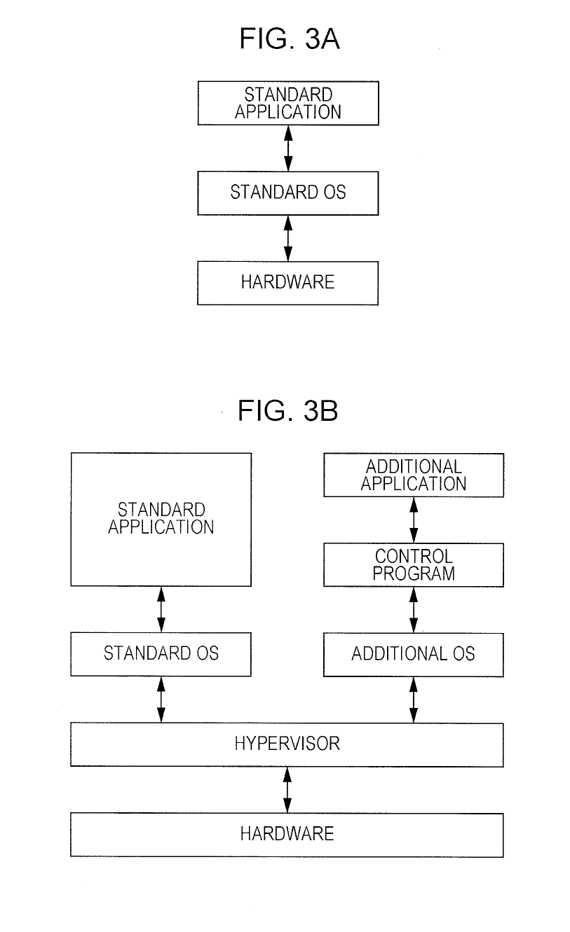

When no group of additional applications (the additional OS program, the additional application program, the control program, and the hypervisor program) is additionally stored in the memory 12C of the apparatus controller 12, the CPU 12A executes the standard OS program while the image forming apparatus 10 is operating, and also executes the standard application program while the standard OS is running (additionally see FIG. 3A). In this case, the image forming apparatus 10 displays, on the display unit 18A, a menu screen displaying a list of choices that are standard functions that may be provided. When the user selects any of the standard functions displayed as the choices on the menu screen, the image forming apparatus 10 displays, on the display unit 18A, an operation screen for designating the details of a process of providing the selected standard function. When the user designates the details of the process via the operation screen and then gives an instruction to execute the process, a process is performed to control the operation of a corresponding hardware (H/W) module (at least one of the image reading unit 14, the image forming unit 16, and the image information sending/receiving unit 20) so that the process with the designated details will be performed.

In contrast, when the foregoing group of additional programs is additionally stored in the memory 12C of the apparatus controller 12, the standard application and the standard OS, and the additional application, the additional OS, and the control program are allocated to different logic sections (virtual environments). As exemplarily illustrated in FIG. 3B, a system (existing system) realized when the standard application runs on the standard OS while the image forming apparatus 10 is operating, and a system (additional system) realized when the additional application and the control program run on the additional OS coexist. A standard function is provided to the user through cooperation of both systems, and a process of providing the standard function is mainly performed by the existing system. In contrast, an additional function is provided by performing, using the additional system, a process of providing the additional function.

Specifically, in the image forming apparatus 10 in operation, the CPU 12A (apparatus controller 12) which executes the additional application program performs screen control of displaying, on the display unit 18A, a menu screen displaying a list of choices that are all functions (standard functions and additional functions) that may be provided to a user. When the user selects any of the functions displayed as the choices on the menu screen, the control program executed by the CPU 12A determines whether the selected function is a standard function provided by a standard application or an additional function provide by an additional application. When the selected function is a standard function provided by a standard application, a process of notifying the standard application of the fact that the standard function has been selected is performed. Accordingly, the CPU 12A (apparatus controller 12) which executes the standard application program displays an operation screen corresponding to the selected standard function. When the user designates the details of a process and gives an instruction to execute the process via the operation screen, a process is performed to control the operation of a corresponding hardware module via the hypervisor so that the process with the designated details will be performed.

In contrast, when the user selects, from among the functions displayed as the choices on the menu screen, an additional function provided by an additional application, the CPU 12A (apparatus controller 12) which executes the additional application program displays, on the display unit 18A, an operation screen for designating the details of a process of providing the selected additional function. When the user designates the details of the process and then gives an instruction to execute the process via the operation screen, a process is performed to control the operation of a corresponding hardware module via the hypervisor so that the process with the designated details will be performed.

In the exemplary embodiment, a process for each process unit that is provided as a standard function when the image forming apparatus 10 executes a standard application program, and a process for each process unit that is provided as an additional function when the image forming apparatus 10 executes an additional application program are collectively referred to as jobs. In the exemplary embodiment, an execution instruction for each job is issued to the image forming apparatus 10, and each job is executed by the image forming apparatus 10. An execution instruction is issued by giving, by a user, an instruction on a menu screen displayed on the display unit 18A or by receiving, by the image forming apparatus 10, an execution instruction sent from a user using the terminal apparatus 80 to the image forming apparatus 10, and the execution instruction is accepted by the apparatus controller 12 of the image forming apparatus 10. Information regarding a job instructed to be executed is managed by a job management unit (described in detail later) in each system (existing system and additional system).

Specific examples of jobs in the exemplary embodiment include a copy process of reading an image of a document and printing the read image (forming the image), a facsimile communication process, a print process of performing printing based on print information, and a scan process of reading an image of a document and saving (or sending) the read image data.

Also, the control program includes a program of a job management process described in detail later. When the CPU 12A executes the control program, the apparatus controller 12 functions as an example of a process information management apparatus that provides a job information management function according to an exemplary embodiment of the invention.

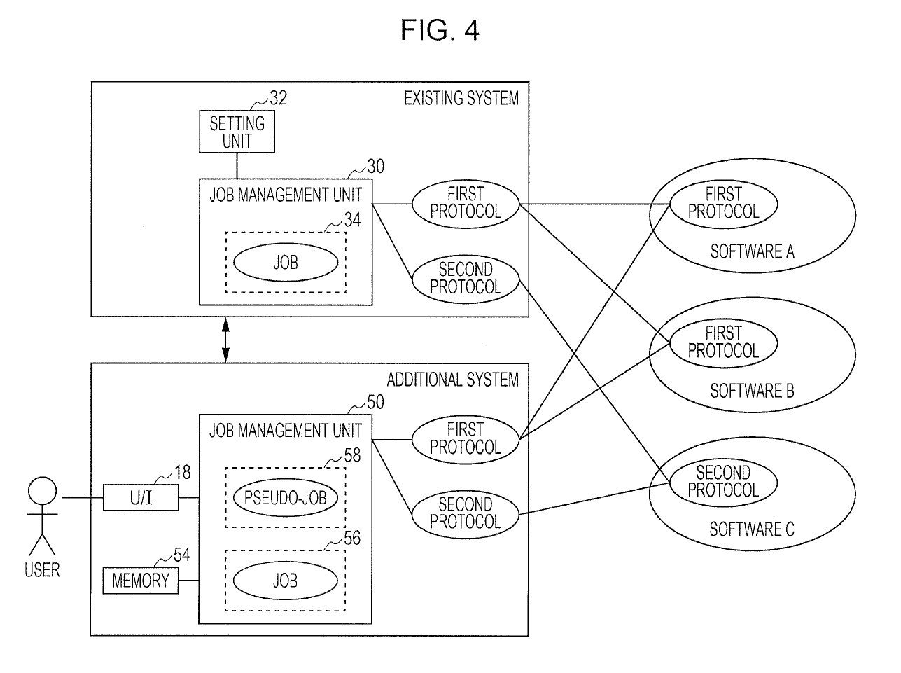

Management of job information according to the exemplary embodiment will be described in detail with reference to the drawings. FIG. 4 is a diagram illustrating an example of the schematic configuration for explaining a job information management function in the process information management apparatus according to the exemplary embodiment.

The existing system includes a job management unit 30, a setting unit 32, and a processor 34 that processes a job. The job management unit 30 has a function of managing information regarding execution of a job by the processor 34 in the existing system, and regarding the executed job. The processor 34 is an example of a first processor according to an exemplary embodiment of the invention. A standard application program is an example of a first application program according to an exemplary embodiment of the invention. A job processed by the processor 34 corresponds to a first process according to an exemplary embodiment of the invention.

In the exemplary embodiment, the existing system has a function of providing a first protocol and a second protocol to application programs (software A, software B, and software C).

These application programs (software A, software B, and software C) are application programs that provide services such as displaying a job state by using the functions of the job management unit 30 and a job management unit 50 using the first protocol or the second protocol provided by the existing system and the additional system.

A specific example of the first protocol includes the Simple Network Management Protocol (SNMP). A specific example of the second protocol includes an interface used by the software C. Specific examples of the software A and the software B include software that provides functions regarding an image forming process such as printer displaying. A specific example of the software C includes a web service.

In contrast, the additional system includes the job management unit 50, a memory 54, a processor 56, a processor 58, and a user interface (U/I) (corresponding to the operation panel in FIG. 1) 18. The job management unit 50 has a function of generating, when a job is executed in the existing system, a job (hereinafter will be referred to as a pseudo-job in order to be distinguishable from a normal job executed by the processor 56) corresponding to the job executed in the existing system, and causing the processor 58 to execute the pseudo-job. The job management unit 50 also has a function of performing management regarding a job executed in the additional system. That is, the job management unit 50 has a function of managing information regarding execution of a job by the processor 56 in the additional system, regarding execution of a pseudo-job (details will be described later), corresponding to a job executed in the existing system, by the processor 58, and regarding the executed jobs.

The processor 56 is an example of a second processor according to an exemplary embodiment of the invention. An additional application program is an example of a second application program according to an exemplary embodiment of the invention. A normal job executed by the processor 56 corresponds to a second process according to an exemplary embodiment of the invention. The processor 58 is an example of a third processor according to an exemplary embodiment of the invention. A pseudo-job executed by the processor 58 corresponds to a third process according to an exemplary embodiment of the invention.

The job management unit 50 provides, to a user, information regarding a job executed via the U/I 18, and accepts an operation regarding execution of a job from the user. The memory 54 has a function of storing information regarding a job managed by the job management unit 50.

In the exemplary embodiment, the additional system has a function of providing the first protocol and the second protocol to the application programs (software A, software B, and software C).

Next, the operation of the exemplary embodiment will be described.

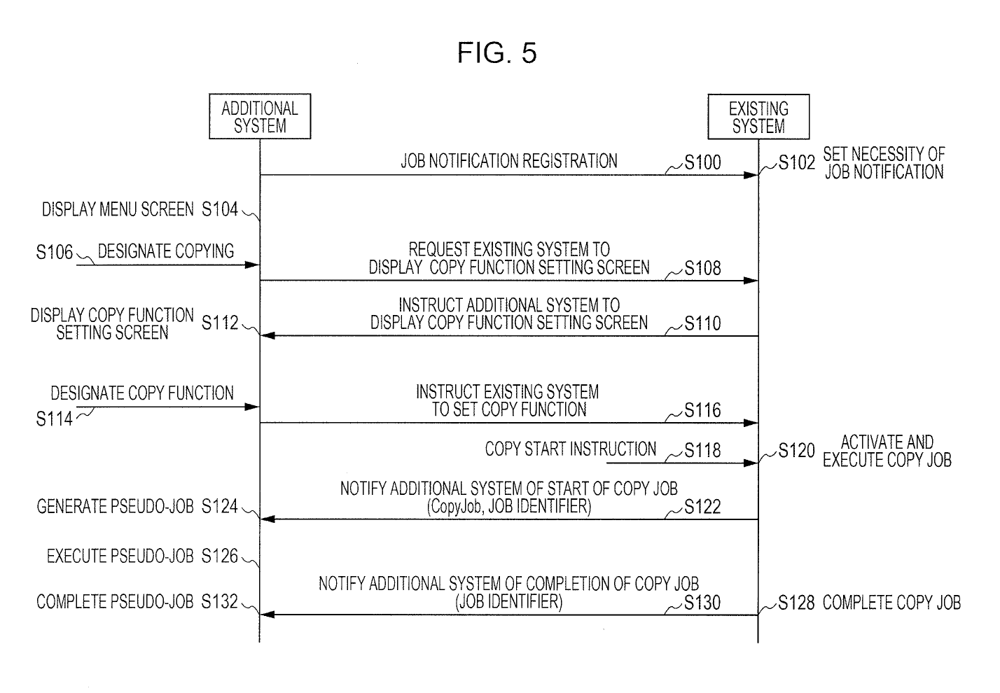

The operation in which the additional system generates a pseudo-job corresponding to a job executed in the existing system, activates the pseudo-job, and completes the pseudo- job will be schematically described. FIG. 5 is a chart illustrating a sequence example in the case where a copy job is executed in the existing system. Here, the copy job is regarded as a specific example of a job executed not in the additional system, but in the existing system. Thus, the existing system has individual functions regarding copying. In the exemplary embodiment, exchange of progress information (start of a job, a change in information, a completion instruction, an operation instruction, etc.) regarding a job executed in the existing system is performed using an interface (not illustrated) for exchanging progress information regarding a job.

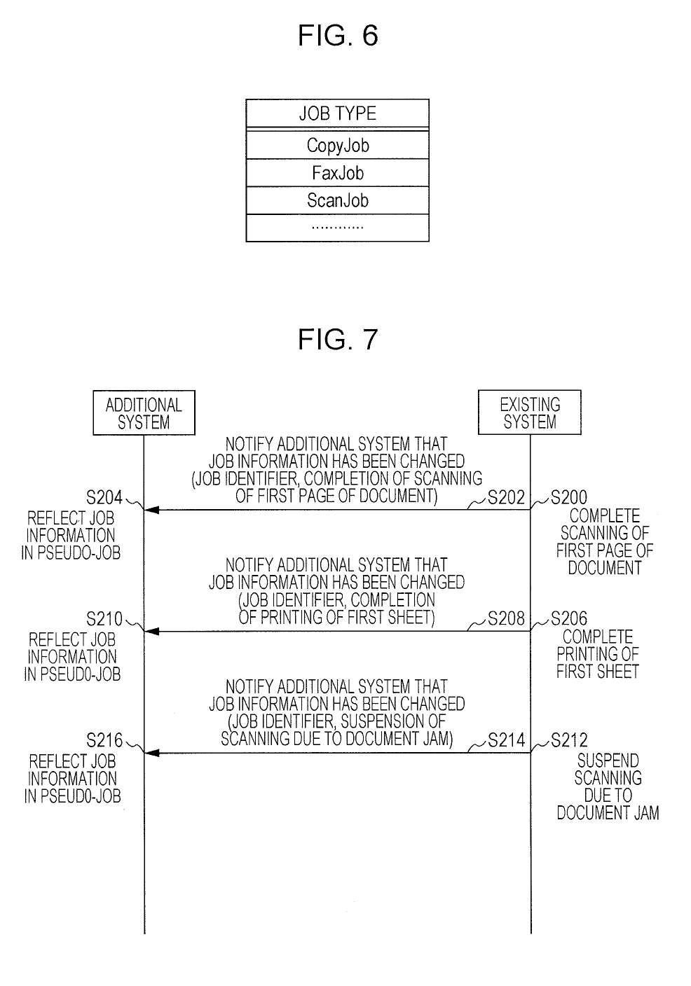

The job management unit 50 in the additional system recognizes the copy job as a job executed in the existing system and as a job that generates and executes a pseudo-job, and issues in advance a job notification registration to the existing system (S100). In response to the job notification registration, the existing system sets the necessity of job notification in the setting unit 32 (S102). By setting the necessity of job notification in the setting unit 32 in this manner, when a job of which notification is required is to be executed in the existing system, the job management unit 30 in the existing system notifies the job management unit 50 in the additional system of information regarding execution of the job. In the exemplary embodiment, the type of job of which notification is performed is set in the setting unit 32. FIG. 6 illustrates specific examples of the types of jobs set in the setting unit 32. In the exemplary embodiment, when a job that has not been set in the setting unit 32 is to be executed in the existing system, notification of information regarding the job is not performed. In the exemplary embodiment, the type of job of which no notification is to be performed (thus, a pseudo-job is not to be generated/executed in the additional system) will be described in detail later.

In the additional system, a menu screen for allowing a user to select a job function is displayed on the U/F 18 (S104). The user designates a job function to use on the menu screen. It is assumed that the user designates copying in this example (S106). When copying is designated, the additional system requests the job management unit 30 in the existing system to display a copy function setting screen (S108). In response to this request, the existing system instructs the U/I 18 in the additional system to display a copy function setting screen (S110). In response to this instruction, a copy function setting screen is displayed on the U/I 18 (S112). The user designates a copy function on the copy function setting screen displayed on the U/I 18 (S114). The additional system instructs the existing system to set the copy function designated by the user (S116).

When the user further gives an instruction to start copying (S118), in the existing system, a copy job is activated, and the processor 34 executes the copy job (S120). When the job management unit 30 detects activation of the copy job, the job management unit 30 notifies the additional system of the fact that the copy job has been activated. In the exemplary embodiment, the additional system is notified of the fact that the activated job is a copy job (the type of activated job), and a job identifier (given to each job in order to identify a job in the existing system) (S122). At this time, the additional system may be additionally notified of information regarding the activated job. The job management unit 50 in the notified additional system generates a pseudo-job corresponding to the copy job (S124). In the exemplary embodiment, a pseudo-job to be generated is equivalent to a job executed in the existing system. Also, the job management unit 50 stores the pseudo-job and the identifier in association with each other in the memory 54. Accordingly, the pseudo-job and the job, which corresponds to the pseudo-job, executed in the existing system are given the same identifier and managed.

The processor 58 executes the pseudo-job under management of the job management unit 50 (S126).

When the job management unit 30 detects completion (S128) of the copy job in the existing system, the job management unit 30 notifies the additional system of the fact that the copy job has been completed (S130). In the exemplary embodiment, the additional system is notified of the job identifier of the completed job. The job management unit 50 in the notified additional system completes execution of the pseudo-job being executed by the processor 56 (S132).

Since the pseudo-job corresponding to the copy job executed in the existing system is generated and executed in the additional system, the job management unit 50 manages the pseudo-job, thereby managing the copy job executed in the existing system in a manner similar to a job executed in the additional system (a job executed by the processor 56).

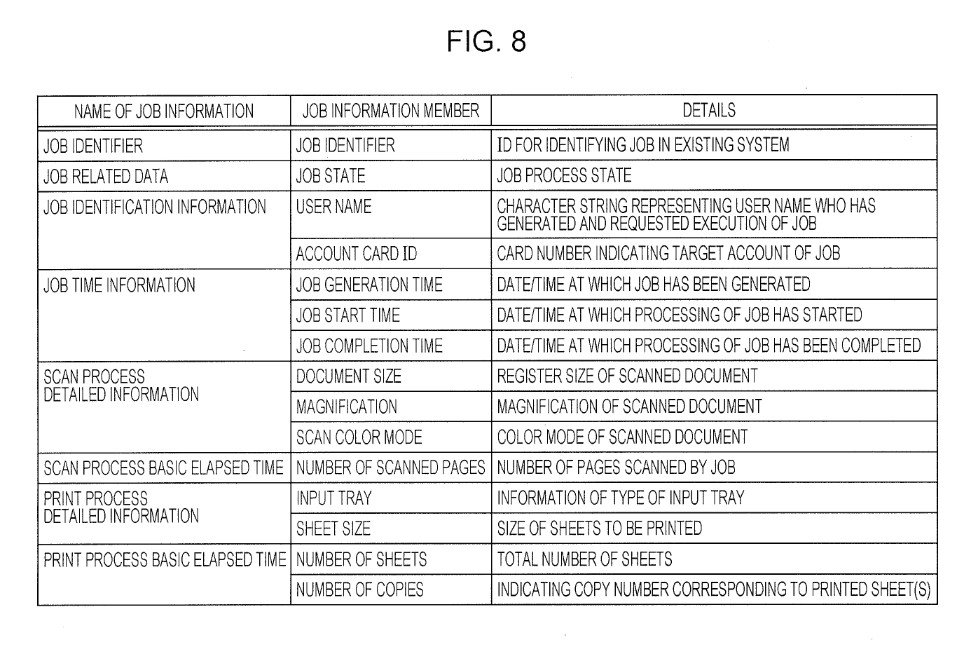

Next, the case where information regarding a job being executed in the existing system is changed will be described. As a specific example, the case where information regarding a copy job is changed while the copy job is being executed in the existing system (S120 in FIG. 5), as described above, will be schematically described. FIG. 7 is a chart illustrating a sequence example in the case where information regarding a copy job being executed in the existing system is changed. FIG. 8 illustrates a specific example of information (job information) regarding a job in the exemplary embodiment. In the exemplary embodiment, as illustrated in FIG. 8, job information includes information regarding a job, and information regarding a progress state of the job. However, job information is not limited to these types of information.

When the job management unit 30 in the existing system detects that the processor 34 has completed scanning of the first page of a document (S200), the job management unit 30 in the existing system notifies the job management unit 50 in the additional system of the fact that the job information has been changed. In the exemplary embodiment, the job management unit 50 in the additional system is notified of the identifier of the changed job and the changed details (completion of scanning of the first page of the document) (S202). The job management unit 50 in the notified additional system reflects the job information in the pseudo-job being executed by the processor 58 (S204). In the exemplary embodiment, the job management unit 50 regards that, in the pseudo-job being executed by the processor 58, scanning of the first page of the document has been completed, and manages and stores that in the memory 54.

When the job management unit 30 in the existing system further detects that the processor 34 has completed printing of the scanned image data on a first sheet (S206), the job management unit 30 in the existing system notifies the job management unit 50 in the additional system of the fact that the job information has been changed. In the exemplary embodiment, as in the above description, the job management unit 50 in the additional system is notified of the identifier of the changed job and the changed details (completion of printing of the first sheet) (S208). The job management unit 50 in the notified additional system reflects the job information in the pseudo-job being executed by the processor 58 (S210). In the exemplary embodiment, the job management unit 50 regards that, in the pseudo-job being executed by the processor 58, printing of the first sheet has been completed, and manages and stores that in the memory 54.

When the job management unit 30 in the existing system detects that, due to a document sheet jam that has occurred in the image forming unit 16, the processor 34 has suspended scanning of the document (S212), the job management unit 30 in the existing system notifies the job management unit 50 in the additional system of the fact that the job information has been changed. In the exemplary embodiment, as in the above description, the job management unit 50 in the additional system is notified of the identifier of the changed job and the changed details (suspension of scanning due to a sheet jam) (S214). The job management unit 50 in the notified additional system reflects the job information in the pseudo-job being executed by the processor 58 (S216). In the exemplary embodiment, the job management unit 50 regards that, in the pseudo-job being executed by the processor 58, scanning has been suspended due to a sheet jam, and manages and stores that in the memory 54.

When the job information of the copy job being executed in the existing system is changed as above, the job information of the pseudo-job being executed in the additional system is similarly changed. Thus, the job management unit 50 manages the pseudo-job, thereby managing the copy job executed in the existing system in a manner similar to a job executed in the additional system (a job executed by the processor 56).

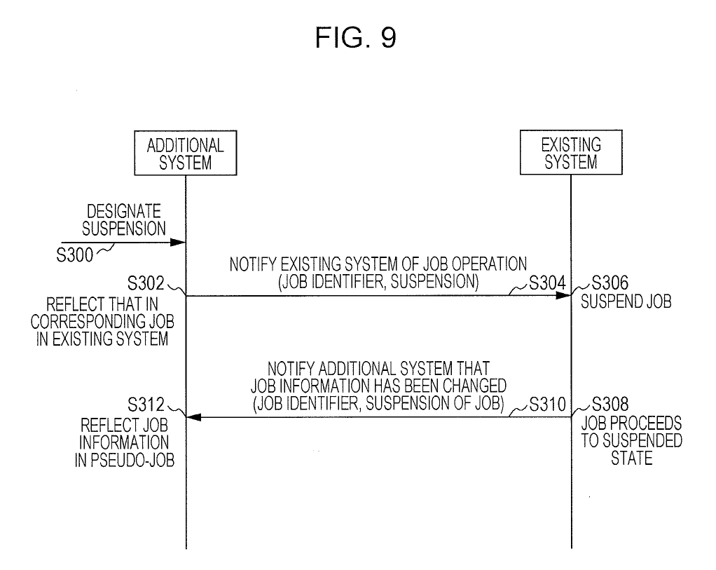

Next, the case where a user gives an instruction (operation) to a pseudo-job being executed in the additional system will be described. As a specific example, the case where a user gives an instruction to suspend copying while a copy job is being executed in the existing system (S120 in FIG. 5), as described above, will be schematically described. In the exemplary embodiment, when a copy job is executed in the existing system, the job management unit 50 in the additional system provides, as a pseudo-job corresponding to the copy job, information to the user via the U/I 18. Therefore, the user gives an instruction to the pseudo-job. FIG. 9 is a chart illustrating a sequence example in the case where the user gives an instruction to suspend copying.

When the user designates, via the U/I 18, suspension of the pseudo-job being executed in the additional system (S300), the job management unit 50 in the additional system performs a process of reading the identifier of the designated pseudo-job from the memory 54 and reflecting that in the job, corresponding to the pseudo-job, in the existing system (S302). The job management unit 50 in the additional system further notifies the job management unit 30 in the existing system of the fact that the job has been operated (designated) by the user. In the exemplary embodiment, the job management unit 30 in the existing system is notified of the identifier of the pseudo-job (the corresponding job in the existing system) and the operation details (suspension) (S304). The job management unit 30 in the notified existing system reflects the job operation in the copy job being executed by the processor 34, and suspends the copy job (S306). Accordingly, the job proceeds to a suspended state in the processor 34 in the existing system (S308).

When the job management unit 30 detects that the job has progressed to a suspended state (S308), the job management unit 30 notifies the job management unit 50 in the additional system of the fact that the job information has been changed. In the exemplary embodiment, as in the above description (see FIG. 7), the job management unit 50 in the additional system is notified of the identifier of the changed job and the changed details (suspension of the job) (S310). The job management unit 50 in the notified additional system reflects the job information in the pseudo-job being executed by the processor 58 (S312). In the exemplary embodiment, the job management unit 50 regards that, in the pseudo-job being executed by the processor 58, copying has been suspended, and manages and stores that in the memory 54.

When the user operates (designates) the pseudo-job being executed in the additional system as above, the job management unit 50 in the additional system notifies the job management unit 30 in the existing system of the identifier of the pseudo-job and the operation details. Thus, the job operation is reflected in the copy job executed in the existing system. In this manner, the job management unit 50 in the additional system has a function of serving as a bridge between the job executed in the existing system and the user. Thus, the user is only required to refer to the job management unit 50 in the additional system, which is more convenient for the user.

Next, the case where the additional system is not notified of a job executed in the existing system will be described. In the exemplary embodiment, as described above, the necessity of notification is set in the setting unit 32 based on an instruction from the job management unit 50. For example, it is set to perform notifications of a copy job and a facsimile job (stored in the setting unit 32), and it is set not to perform notifications of a scan job and a print job (not stored in the setting unit 32). In particular, in the exemplary embodiment, when a partial process included in a job executed by the processor 56 in the additional system is to be processed using a function of the existing system, it is set not to notify the additional system, by the existing system, of the process (job) using the existing system.

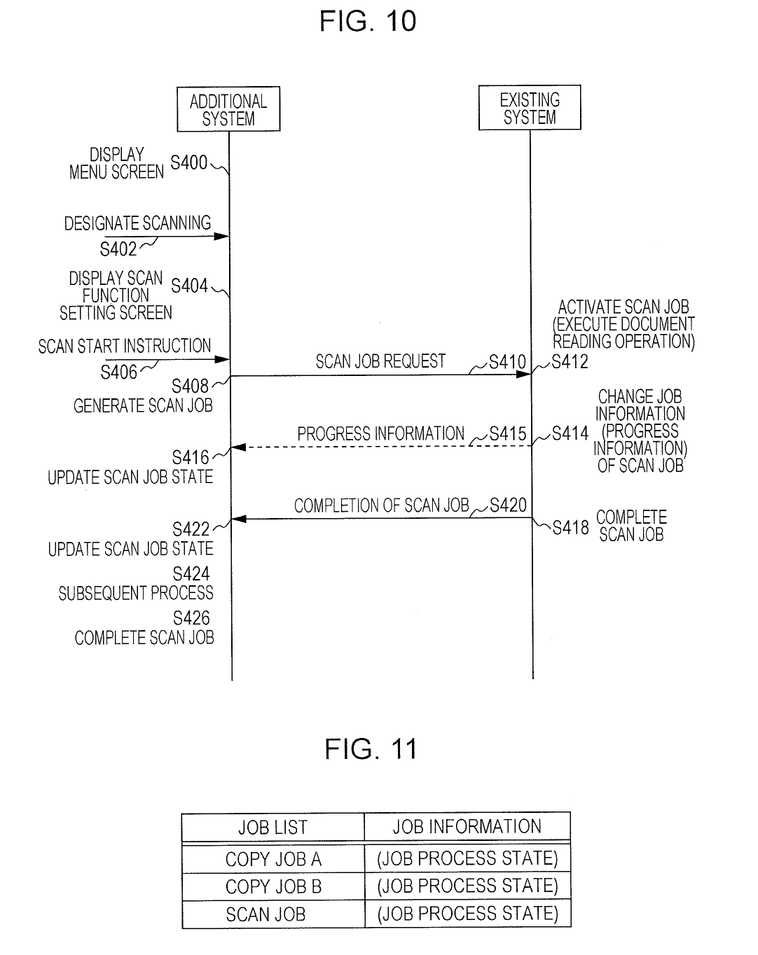

As a specific example, the case where a scan job is executed by the processor 56 in the additional system will be schematically described. FIG. 10 is a chart illustrating a sequence example of the case where a scan job that uses a function included in the existing system is executed by the processor 56 in the additional system. A scan job executed by the processor 34 in the existing system, which is illustrated in FIG. 10, is to execute only a process of reading a document image. In contrast, a scan job executed by the processor 56 in the additional system executes a process of reading a document image by causing the scan job to be executed using the processor 34 in the existing system, and thereafter, executes, with the processor 56, a subsequent process on the read document image data using optical character reader (OCR) software or the like.

In the additional system, a menu screen for allowing a user to select a job function is displayed on the U/I 18 (S400). The user designates a job function to use on the menu screen. It is assumed that the user designates scanning (S402). When scanning is designated, the additional system displays a scan function setting screen on the U/I 18 (S404). The user sets a scan function on the scan function setting screen displayed on the U/I 18, and further givens an instruction to start scanning (S406). In response to the instruction, the additional system generates a scan job and executes, with the processor 56, the scan job (S408). Additionally, the additional system requests the job management unit 30 in the existing system to execute a scan job (S410).

In response to the request, the existing system activates a scan job and executes an operation of reading the document (S412). In the exemplary embodiment, the existing system does not notify the additional system of the fact that the scan job has been activated and executed. However, since the scan job is being executed by the processor 56 in the additional system, the scan job is being managed by the job management unit 50.

In the exemplary embodiment, when a partial process included in a job executed by the processor 56 in the additional system is to be processed using a function of the existing system, progress information regarding the process is exchanged using an interface for the process while the process (job) using the existing system is being executed. In the case illustrated in FIG. 10, progress information (job information) of the scan job is exchanged using an interface for scanning (not illustrated) while a job regarding document reading is being executed (from activation to completion of a process of reading the document).

For example, when job information (progress information) of the scan job is changed in the existing system (S414), a notification thereof is performed using the interface (S415), and the state of the scan job is updated in the additional system (S416). In this manner, a notification of progress information regarding document reading and an operation regarding document reading are performed using the interface.

When the scan job is completed in the existing system (S418), the additional system is notified of completion of the scan job (document reading) (S420). The job management unit 50 in the additional system updates the state of the scan job executed by the processor 56 since document reading has been completed (S422). Thereafter, the processor 56 in the existing system performs a subsequent process (S424) such as the above-described process using OCR software, and, when the subsequent process ends, the scan job is completed (S426).

In this manner, when a job executed by the processor 34 in the existing system is a job that covers a partial process of a job executed by the processor 56 in the additional system, the existing system does not notify the additional system of this job.

In the exemplary embodiment, information regarding a job managed by the job management unit 50 is provided to a user via the U/I 18. As a specific example, when the user gives, using the U/I 18, an instruction to check a job list in order to check jobs that have been executed by the image forming apparatus 10 (a job that has been executed in the existing system and a job that has been executed in the additional system), in the exemplary embodiment, the job management unit 50 in the additional system displays, on the

U/I 18, job information stored in the memory 54 as a job list. FIG. 11 illustrates a specific example of a job list. As copy jobs (copy job A and copy job B) executed in the existing system, items of job information (e.g., job process states) of corresponding pseudo-jobs are displayed, and job information (e.g., job process state) of a scan job executed by the processor 56 in the additional system is displayed.

In this manner, since the job management unit 50 in the additional system in the exemplary embodiment collectively manages job information of a job executed by the processor 56 and job information of a pseudo-job that may be regarded as a job executed in the existing system, these items of job information are collectively provided to a user.

As described above, in the exemplary embodiment, when a job is activated and executed in the existing system, the job management unit 50 in the additional system generates a pseudo-job corresponding to this job (performs a similar process), and executes the pseudo-job using the processor 58. The job management unit 50 manages information regarding a process of a pseudo-job performed by the processor 58 and information regarding a process of a job executed by the processor 56.

The job management unit 30 in the existing system and the job management unit 50 in the additional system manage jobs that are executed in the respective systems. Since a pseudo-job corresponding to a job executed in the existing system is executed in the additional system, a job actually executed in the existing system may be regarded as a job executed in the additional system. Therefore, the job management unit 50 in the additional system is able to manage all jobs executed in both systems. Thus, the user friendliness is improved, compared with the case where no pseudo-job is performed for regarding a job executed in the existing system as a job executed in the additional system. Because functions such as the software A, the software B, and the software C may be provided without changing interfaces such as the first protocol and the second protocol described above, development efficiency is improved.

Although the case where the existing system is a system realized on the standard OS, and the additional system is a system realized on the additional OS has been described in the exemplary embodiment, the existing system and the additional system are not limited thereto. The existing system and the additional system may be realized on the same OS. The existing system and the additional system may be any systems as long as they have individual job management units that individually manage jobs executed in the respective systems.

Although the case where there is one existing system and one additional system has been described in the exemplary embodiment, the number of existing systems and the number of additional systems are not limited to one. For example, there may be plural existing systems. When there are plural systems, a job management unit of any of these systems, such as the most newly added system (additional system), may generate, execute, and manage a pseudo-job corresponding to a job in another system (existing system).

Although the case where the additional system and the existing system are included in the same image forming apparatus 10 has been described in the exemplary embodiment, the configuration is not limited thereto. Either of the systems may be configured so as to be connected to the other system through a network.

Although the case where the existing system and the additional system realized by the apparatus controller 12 included in the image forming apparatus 10 are systems that execute jobs regarding image formation has been described in the exemplary embodiment, the apparatus controller 12 is not limited thereto. The apparatus controller 12 may be a process information management apparatus that provides a job management function for managing other jobs, or may be included in another apparatus different from the image forming apparatus 10.

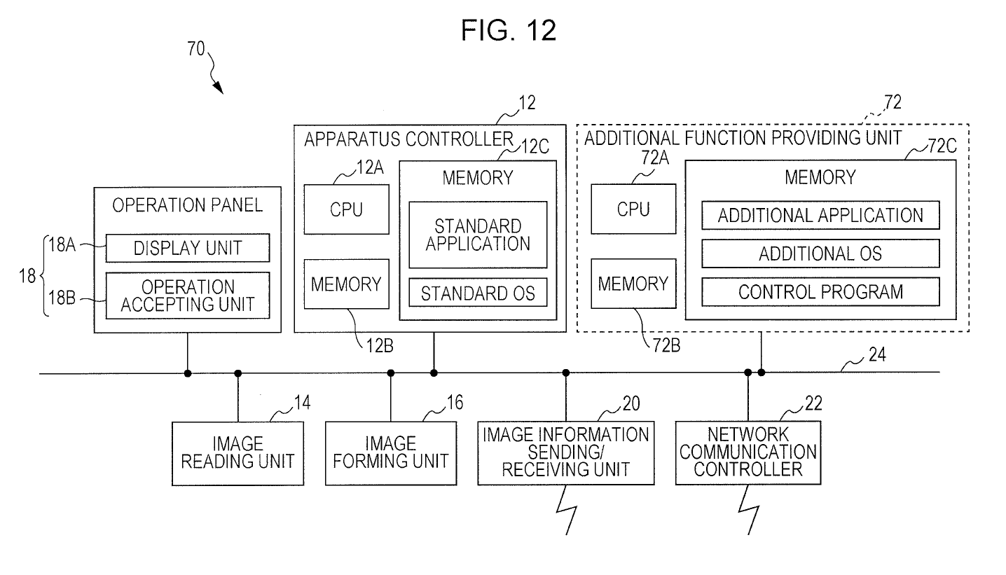

Although the case where the standard application, which is an example of the first application program, the additional application program, which is an example of the second application program, and the control program are executed by the CPU 12A of the apparatus controller 12 has been described above, the exemplary embodiment of the invention is not limited to this case. For example, as illustrated in FIG. 12, the exemplary embodiment of the invention is applicable to a configuration to which a function that may be provided to a user is added by inserting an additional function providing unit 72 including a microcomputer or the like into an extension slot provided in an image forming apparatus 70. The additional function providing unit 72 includes a CPU 72A, a memory 72B, and a non-volatile memory 72C storing an additional OS program, an additional application program, and a control program.

The additional function providing unit 72 in this configuration is an example of an additional computer, and the additional OS program, the additional application program, and the control program are executed by the CPU 72A of the additional function providing unit 72. In the configuration in FIG. 12, for example, the control program may be stored in the memory 12C of the apparatus controller 12 and may be executed by the CPU 12A.

Although the case where a program serving as an example of a control program of an image forming apparatus according to an exemplary embodiment of the invention is additionally stored in the memory 12C of the apparatus controller 12 has been described above, the control program of the image forming apparatus according to the exemplary embodiment of the invention may be provided as being recorded in a recording medium such as a compact disc read-only memory (CD-ROM) or a digital versatile disc read-only memory (DVD-ROM). Alternatively, the control program may be provided via a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A process information management apparatus comprising:
a first processor that executes a first process for each process unit instructed to be executed, based on a first application program in an environment where a first system is operating;
a management unit that manages information regarding a process executed in an environment where a second system is operating, based on a second application program in the environment where the second system is operating;
a second processor that executes a second process for each process unit instructed to be executed, based on the second application program in the environment where the second system is operating;
a generator that generates, when the first processor executes the first process, an execution instruction for causing a third process corresponding to the first process to be executed in order to regard that the first process is executed in the environment where the second system is operating, and, when the first processor completes the first process, generates a completion instruction for completing execution of the third process; and
a third processor that executes, based on the second application program in the environment where the second system is operating, the third process in accordance with the execution instruction generated by the generator, and completes the third process in accordance with the completion instruction.

2. The process information management apparatus according to claim 1, further comprising a setting unit that sets, for each type of the first process, whether the generator generates an execution instruction for the third process.

3. The process information management apparatus according to claim 2, wherein, when the second process includes a predetermined type of the first process, the setting unit sets not to generate an execution instruction for the third process corresponding to the predetermined type of the first process.

4. The process information management apparatus according to claim 1, wherein the management unit receives information regarding execution of the first process being executed by the first processor, and manages the received information as information regarding execution of the third process corresponding to the first process.

5. The process information management apparatus according to claim 1, further comprising an instruction unit that gives an instruction for a process executed in the second system,
wherein the management unit notifies the first processor, which executes the first process corresponding to the third process, of an instruction for the third process given by the instruction unit.

6. The process information management apparatus according to claim 1, further comprising an output unit that outputs information regarding the second process executed by the second processor and information regarding the third process executed by the third processor, in the environment where the second system is operating.

7. An image forming apparatus comprising the process information management apparatus according to claim 1, wherein the first process and the second process are information regarding image formation.

8. A computer readable medium storing a program causing a computer to execute a process, the process comprising:
executing a first process for each process unit instructed to be executed, based on a first application program in an environment where a first system is operating;
managing information regarding a process executed in an environment where a second system is operating, based on a second application program in the environment where the second system is operating;
executing a second process for each process unit instructed to be executed, based on the second application program in the environment where the second system is operating;
generating, when the first process is executed, an execution instruction for causing a third process corresponding to the first process to be executed in order to regard that the first process is executed in the environment where the second system is operating, and, when the first process is completed, generating a completion instruction for completing execution of the third process; and
executing, based on the second application program in the environment where the second system is operating, the third process in accordance with the execution instruction, and completing the third process in accordance with the completion instruction.

9. A process information management method comprising:
executing a first process for each process unit instructed to be executed, based on a first application program in an environment where a first system is operating;
managing information regarding a process executed in an environment where a second system is operating, based on a second application program in the environment where the second system is operating;
executing a second process for each process unit instructed to be executed, based on the second application program in the environment where the second system is operating;
generating, when the first process is executed, an execution instruction for causing a third process corresponding to the first process to be executed in order to regard that the first process is executed in the environment where the second system is operating, and, when the first process is completed, generating a completion instruction for completing execution of the third process; and
executing, based on the second application program in the environment where the second system is operating, the third process in accordance with the execution instruction, and completing the third process in accordance with the completion instruction.
